(19) United States
(12) Patent Application Publication
(10) Pub. No.: US 2014/0129805 A1
(43) Pub. Date: May 8, 2014

(54) EXECUTION PIPELINE POWER REDUCTION

(71) Applicant: NVIDIA CORPORATION, San Clara, CA (US)

(72) Inventor: Don Husby, Aloha, OR (US)

(73) Assignee: NVIDIA Corporation, Santa Clara, CA (US)

(21) Appl. No.: 13/672,585

(22) Filed: Nov. 8, 2012

(51) Int. Cl. G06F 9/312

(52) U.S. Cl. 712/214; 712/E09.033

(57) ABSTRACT

Systems and methods for reducing power consumption by an execution pipeline are provided. In one example, a method includes stalling an operation from being executed in the execution pipeline based on inputs to the operation being unavailable in a register file and disabling access to read the register file in favor of controlling a bypass network based on the consumer characteristics of the operation and producer characteristics of other operations being executed in the execution pipeline to forward data produced at an execution stage in the execution pipeline to be used as one or more resources of the operation.

### BACKGROUND

An operation may be stalled from being executed in an execution pipeline for a variety of reasons. In one example, an operation may be stalled as a result of data dependencies. In particular, a consuming operation may be stalled while another operation in the execution pipeline continues execution to produce a result that is to be used as an input by the consuming operation. Once the result is produced by the producing operation, the result is passed through the execution pipeline and is written to a register file where the result is available as an input to the consuming operation. Accordingly, the consuming operation may be executed in the execution pipeline and the stall can be resolved.

In one example, during a stall, a read request is issued to the register file for each clock cycle of the stall to check for availability of a result in the register file. In particular, the result is to be used as an input to a consuming operation that is being stalled. By issuing the read request every clock cycle during the stall, it can be determined that the result is available as soon as it is written to the register file. In this way, the stall can be resolved as soon as the result is written to the register file.

However, repeatedly accessing the register file via read requests may consume a significant amount of power. Accordingly, in order to reduce power consumption of the execution pipeline it may be desirable to avoid a read of the register file every clock cycle during a stall.

### BRIEF DESCRIPTION OF THE DRAWINGS

FIG. 1 schematically shows an example micro-processing system in accordance with an embodiment of the present disclosure.

FIG. 2 schematically shows an example execution pipeline in accordance with an embodiment of the present disclosure.

FIG. 3 schematically shows another example execution pipeline in accordance with an embodiment of the present disclosure.

FIG. 4 shows an example method for controlling an execution pipeline to reduce power consumption in accordance with an embodiment of the present disclosure.

### DETAILED DESCRIPTION

The present discussion sets forth novel systems and methods for controlling an execution pipeline in such a manner that power consumption may be reduced. More particularly, the present discussion relates to an approach for disabling access to a register file during a stall in the execution pipeline to reduce power consumption. For example, when an instruction has been decoded and a corresponding operation is to be executed in the execution pipeline, the register file and a resource tracker may be initially accessed. In particular, these initial accesses of the register file and the resource tracker may provide information in cooperation with information provided from decoding of the instruction to determine whether data necessary to execute the operation is available in the register file or will be produced in the execution pipeline by another operation. If data to be used as an input of the operation is unavailable, then the operation is stalled.

The information from the resource tracker may include consumer and producer characteristics of operations in the execution pipeline that may be used to control a bypass network operatively coupled with the execution pipeline. In particular, the information read from the resource tracker can be used to control the bypass network to forward data produced as a result of another operation already in the execution pipeline to be used as an input to the operation that is being stalled. In other words, the data needed to resolve the stall may be provided via the bypass network instead of the register file based on the consumer and producer characteristics provided by the resource tracker, and thus access to the register file may be disabled during the stall. By not accessing the register file during the stall, power consumption may be reduced relative to an approach where the register file is accessed at each clock cycle of the stall to check for availability of the input data. Moreover, by controlling the bypass network to forward data based on the information from the resource tracker, in some cases, data produced as a result of another operation may be forwarded as an input before it would otherwise be available in the register file. Accordingly, in some cases, performance of the execution pipeline may be increased relative to an approach that merely reads data from a register file to resolve a stall.

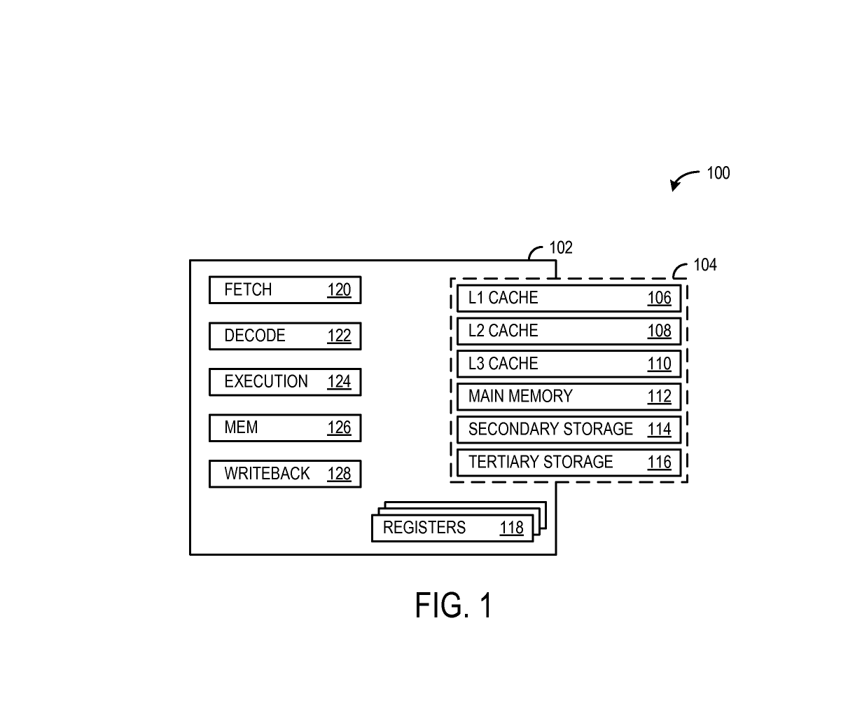

FIG. 1 shows aspects of an example micro-processing and memory system 100 (e.g., a central processing unit or graphics processing unit of a personal computer, game system, smartphone, etc.) including a processor core 102. Although the illustrated embodiment includes only one processor core, it will be appreciated that the micro-processing system may include additional processor cores in what may be referred to as a multi-core processing system. The microprocessor core/die variously includes and/or may communicate with various memory and storage locations 104.

The memory and storage locations 104 may include L1 processor cache 106, L2 processor cache 108, L3 processor cache 110, main memory 112 (e.g., one or more DRAM chips), secondary storage 114 (e.g., magnetic and/or optical storage units) and/or tertiary storage 116 (e.g., a tape farm). The processor core 102 may further include processor registers 118. Some or all of these locations may be memory-mapped, though in some implementations the processor registers may be mapped differently than the other locations, or may be implemented such that they are not memory-mapped. It will be understood that the memory/storage components are listed above in increasing order of access time and capacity, though there are possible exceptions. In some embodiments, a memory controller may be used to handle the protocol and provide the signal interface required of main memory, and, typically, to schedule memory accesses. The memory controller may be implemented on the processor die or on a separate die. It is to be understood that the locations set forth above are non-limiting and that other memory/storage locations may be used instead of, or in addition to, those described above without departing from the scope of this disclosure.

The micro-processor 102 includes a processing pipeline which typically includes one or more of fetch logic 120, decode logic 122 (referred to herein as a hardware decoder or hardware decode logic), execution logic 124, mem logic 126, and writeback logic 128. Note that one or more of the stages in the processing pipeline may be individually pipelined to include a plurality of stages or subunits to perform various associated operations.

The fetch logic 120 retrieves instructions from one or more of memory locations (e.g., unified or dedicated L1 caches backed by L2-L3 caches and main memory). In some examples, instructions may be fetched and executed one at a time, possibly requiring multiple clock cycles. Fetched instruction code may be of various forms. In addition to instructions natively executable by the execution logic of the processor core, fetch logic may also retrieve instructions compiled to a non-native instruction ISA. One illustrative example of a non-native ISA that the micro-processing system may be configured to execute is the 64-bit Advanced RISC Machine (ARM) instruction set; another is the x86 instruction set. Indeed, the full range of non-native ISAs here contemplated includes reduced instruction-set computing (RISC) and complex instruction-set computing (CISC) ISAs, very long instruction-word (VLIW) ISAs, and the like. The ability to execute selected non-native instructions provides a practical advantage for the processing system, in that it may be used to execute code compiled for pre-existing processing systems.

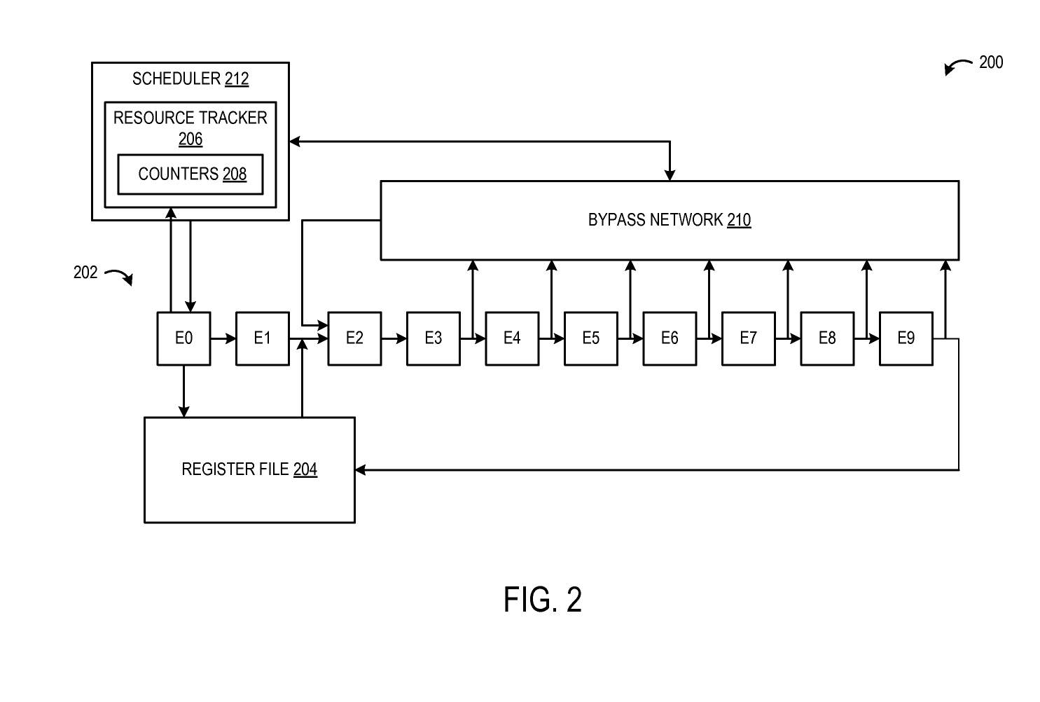

Such non-native instructions may be decoded by the decode logic 122 into the native ISA to be recognized by the execution logic 124. For example, the hardware decoder may parse op-codes, operands, and addressing modes of the non-native instructions, and may create a functionally equivalent, but non-optimized set of native instructions. When the fetch logic retrieves a non-native instruction, it routes that instruction through the hardware decoder to a scheduler 212 (shown in FIG. 2 as part of the execution logic). On the other hand, when the fetch logic retrieves a native instruction, that instruction is routed directly to the scheduler, by-passing the hardware decoder. Upon being decoded, the instructions may be dispatched by the scheduler to be executed by an execution pipeline of the execution logic.

The scheduler dispatches the instructions, as appropriate, to the execution logic 124. The execution logic may include an execution pipeline having a plurality of execution stages configured to execute operations decoded from instructions. The execution pipeline may include execution stages such as integer execution units, floating-point execution units, load/store units, or jump-stats and retirement (JSR) units. In one embodiment, the processor core may be a so-called in-order processor, in which instructions are retrieved and executed in substantially the same order—i.e., without resequencing in the scheduler. Correspondingly, the execution pipeline may be an in-order execution pipeline in which instruction are executed in the order in which they are dispatched.

As instructions are executed in the execution stages of the execution pipeline, a sequence of logical and/or arithmetic results evolves therein. For operations that produce a primary result (e.g., as opposed to those that perform a branch to another location in the executing program), writeback logic writes the result to an appropriate location, such as a processor register. In load/store architectures, mem logic performs load and store operations, such as loading an operand from main memory into a processor register. Note, in some cases, an instruction may correspond to a single operation. In other cases, an instruction may correspond to multiple operations.

As will be discussed in further detail below, the execution logic may be controlled to disable reads of a register file during a stall of an operation. Such control may be based on consumer and producer characteristics of the operation that may be detected during decode of an instruction corresponding to the operation by the decode logic as well as consumer and producer characteristics of other operations being executed by the execution logic. By not accessing the register file during the stall, power consumption may be reduced relative to an approach where the register file is accessed at each clock cycle of the stall to check for resource availability.

It should be understood that the five stages discussed above are somewhat specific to, and included in, a typical RISC implementation. More generally, a microprocessor may include fetch, decode, and execution logic, with mem and writeback functionality being carried out by the execution logic. For example, the mem and writeback logic may be referred to herein as a load/store portion or load/store unit of the execution logic. Further, it should be understood that the micro-processor system is generally described in terms of an in-order processing system, in which instructions are retrieved and executed in substantially the same order—i.e., without resequencing in the scheduler. Correspondingly, the execution logic may include an in-order execution pipeline in which instruction are executed in the order in which they are dispatched. The present disclosure is equally applicable to these and other microprocessor implementations, including hybrid implementations that may use out-of order processing, VLIW instructions and/or other logic instructions.

FIG. 2 schematically shows an example execution pipeline 200. In one example, the execution pipeline 200 may be implemented in the micro-processing system 100 shown in FIG. 1. The execution pipeline includes a sequence of execution stages 202 configured to execute operations of instructions. In one example, the sequence of execution stages are pipelined stages of an individual execution unit, such as an arithmetic logic unit (ALU). In the illustrated embodiment, the execution pipeline includes ten execution stages (i.e., E0-E9). More particularly, in the illustrated embodiment, the first two execution stages E0 and E1 serve as decode and preparation stages where instructions are decoded to determine operations for execution and data is gathered for input to the operations, and execution actually begins at execution stage E2. It will be appreciated that the execution pipeline may include any suitable number and type of execution stages, arranged in any suitable order, without departing from the present disclosure.

The execution pipeline 200 is operatively coupled with a register file 204 such that data produced as a result of an operation by an execution stage in the execution pipeline may be written to the register file. Further, the register file may be read to retrieve data including data used for inputs of operations that are executed in the execution pipeline. In the illustrated embodiment, data read from the register file is provided to the input of execution stage E2. The register file may include any suitable number of registers without departing from the scope of the present disclosure.

A bypass network 210 is operatively coupled with the execution pipeline 200. The bypass network is configured to forward data produced at one or more execution stages to another execution stage earlier in the sequence of execution stages to be consumed as an input. In other words, the bypass network may forward data to be used as an input before it would otherwise be available in the register file. In one example, the bypass network includes one or more multiplexors that are controlled to select an output of one of the execution stages to pass to the input of another execution stage. In the illustrated embodiment, the bypass network 210 may receive data output from any one of execution stages E3-E9. Further, the bypass network may be configured to forward the data to the input of execution stage E2. The bypass network includes inputs from multiple execution stages because different operations take a different number of cycles to produce a result. In some cases, as soon as result is produced from an execution stage, the data may be fed back to execution stage E2 to be consumed. In this way, the execution pipeline may operate in an efficient manner. In some cases, a result may be fed back to execution stage E2 and held until data for another input of the corresponding operation is produced so that all data can be available in order to avoid a data hazard. Note although not shown it will be appreciated that each execution stage may include one or more flip-flops or latches to transiently store input/output data.

A resource tracker 206 may be configured to track consumer and producer characteristics of operations in the execution pipeline. For example, when an instruction is dispatched to the execution pipeline and an operation is decoded (e.g., at execution stage E0), the resource tracker may determine the consumer and producer characteristics of that operation. In one example, the consumer characteristics for an operation include a type of operation, an execution stage in which one or more inputs of the operation are consumed, and registers associated with one or more inputs of the operation. In one example, the producer characteristics for an operation include a type of operation, an execution stage in which a result of the operation is produced, and a register associated with the result of the operation. Further, a status of the resource tracker may be updated with producer characteristics of an operation upon completion of execution of that operation.

In one example, the resource tracker 206 includes a plurality of counters 208 that may be set to track on what cycle and execution stage the needed data will be produced, and on what cycle the needed data will be consumed. For example, counters may be set when an operation is decoded at execution stage E0 and the producer and consumer characteristics are determined by the resource tracker. Further, as the operation is executed in the execution pipeline the counters may be decremented with each clock cycle to track when data will be available for consumption. In one example, the resource tracker includes a counter corresponding to each register in the register file to track when data associated with that register is consumed or produced in the execution pipeline. Data produced as a result may be assigned to a register according to an instruction. If data from a different instruction is assigned to the same register, the resource tracker may set the corresponding counter according to the most recent instruction. In some embodiments, the resource tracker 206 is located in the execution pipeline 200. In some embodiments, the resource tracker 206 is located in the scheduler 212.

The scheduler 212 may be configured to control the execution pipeline 200 and the bypass network 210 to execute an operation based on the consumer and producer characteristics of that operation as well as other operations being executed in the execution pipeline. For example, when an instruction is decoded by decode logic and a resulting operation is dispatched to the execution pipeline for execution, the scheduler may receive consumer and producer characteristics of the operation. Further, the scheduler performs a read of the register file to determine if resources to execute the operation are available in the register file. In one non-limiting example, resources include data for all inputs of the operation. Further still, the scheduler queries the resource tracker for consumer and producer characteristics of other operations in the execution pipeline. In some embodiments, the scheduler queries the resource tracker in parallel with the read of the register file at the first execution stage.

The scheduler may be configured to stall the operation from being executed in the execution pipeline based on one or more resources of the operation being unavailable in the register file. In one example, a resource is unavailable if a register is busy waiting for an operation in the execution pipeline to produce a result. For example, a busy bit may be set for a register when an operation that produces a result that is written to that register enters the pipeline. Once the data is written to the register file, the busy bit may be cleared. Since the resource tracker tracks what operations have been dispatched previously and tracks the producer and consumer characteristics of those operations, the scheduler may know where data is in the execution pipeline and when it will be available to be consumed by the operation, and thus can calculate a number of cycles to stall.

Furthermore, the scheduler may be configured to disable access to read the register file during the stall. In one example, the scheduler is configured to disable access to read the register file until the operation is executed in the execution pipeline and the stall is resolved. The scheduler disables access to read the register file during the stall because the resource tracker provides enough information to know when data in the execution pipeline will be available to be consumed. Accordingly, a read of the register file each clock cycle to check for data to become available during a stall may be avoided. In this way, power consumption of the execution pipeline may be reduced.

Further still, the scheduler may be configured to control the bypass network based on the consumer and producer characteristics of the operation as well as other operations in the execution pipeline to forward data produced at an execution stage in the execution pipeline to be used as one or more resources of the operation. In particular, the scheduler controls the bypass network based on the producer characteristics of the other operations received from the resource tracker and the consumer characteristics of the stalled operation received from the decode logic to resolve the stall. In one example, the bypass network includes a multiplexor and a select line of the multiplexor is controlled based on the counters in the resource tracker. Read access to the register file is disabled during the stall in favor of controlling the bypass network to provide data from a producing operation as an input of the stalled operation. By forwarding data via the bypass network to be consumed as input of the stalled operation, such data may be consumed quickly, and correspondingly the stall may be resolved quickly. In some cases, by forwarding the data via the bypass network the stall may be resolved quicker than waiting for the data to become available in the register file and then reading the data from the register file.

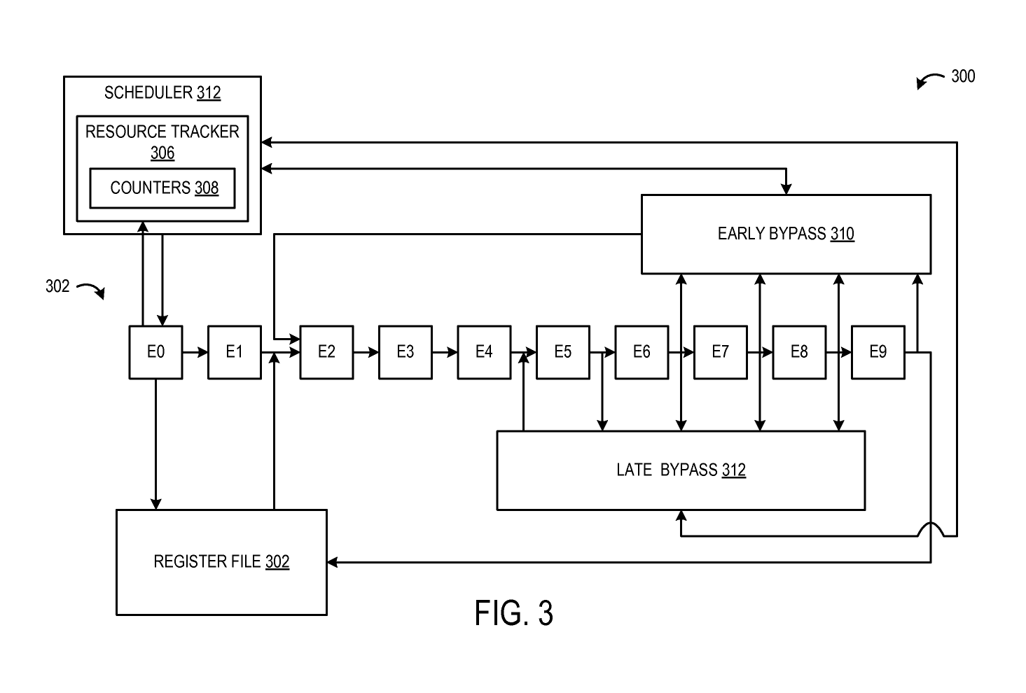

FIG. 3 shows another embodiment of an execution pipeline 300. Components of the execution pipeline 300 that may be substantially the same as those of the execution pipeline 200 are identified in with corresponding references and are described no further. However, it will be noted that components identified in the same way in different embodiments of the present disclosure may be at least partly different. In one example, the execution pipeline 300 may be implemented in the micro-processing system 100 shown in FIG. 1.

The execution pipeline 300 includes a bypass network that includes an early bypass 310 and a late bypass 312. In one example, the early bypass is configured to forward data to an execution stage of the execution pipeline and the late bypass is configured to forward data to another execution stage that is located after that execution stage in the execution pipeline. In the illustrated embodiment, the early bypass is configured to forward data produced by any of execution stages E6-E9 to be consumed by execution stage E2. The late bypass is configured to forward data produced by any of execution stage E5-E8 to be consumed by execution stage E5. Note that in this example, execution stages E0 and E1 are decode and preparation stages and actual execution of an operation may begin at execution stage E2.

The combination of the early and late bypasses enable data to be forwarded to operations consuming data at the beginning of the execution pipeline as well as operations that consume data later in the execution pipeline. In other words, by implementing the early and late bypasses, stalls may be reduced and performance of the execution pipeline may be increased by not having to wait for data to be written to the register file as often. The scheduler 124 may be configured to control operation of the early bypass 310 and the late bypass 312 based on consumer and producer characteristics of operations in the execution pipeline tracked by the resource tracker 306 to determine stalls and disable reads of the register file during these stalls. In some embodiments, the bypass network may be configured to forward data produced in an earlier stage to be used as input to a later stage in the execution pipeline. In some embodiments, the bypass network may be configured to forward data from a stage of one execution unit to a stage of another execution unit.

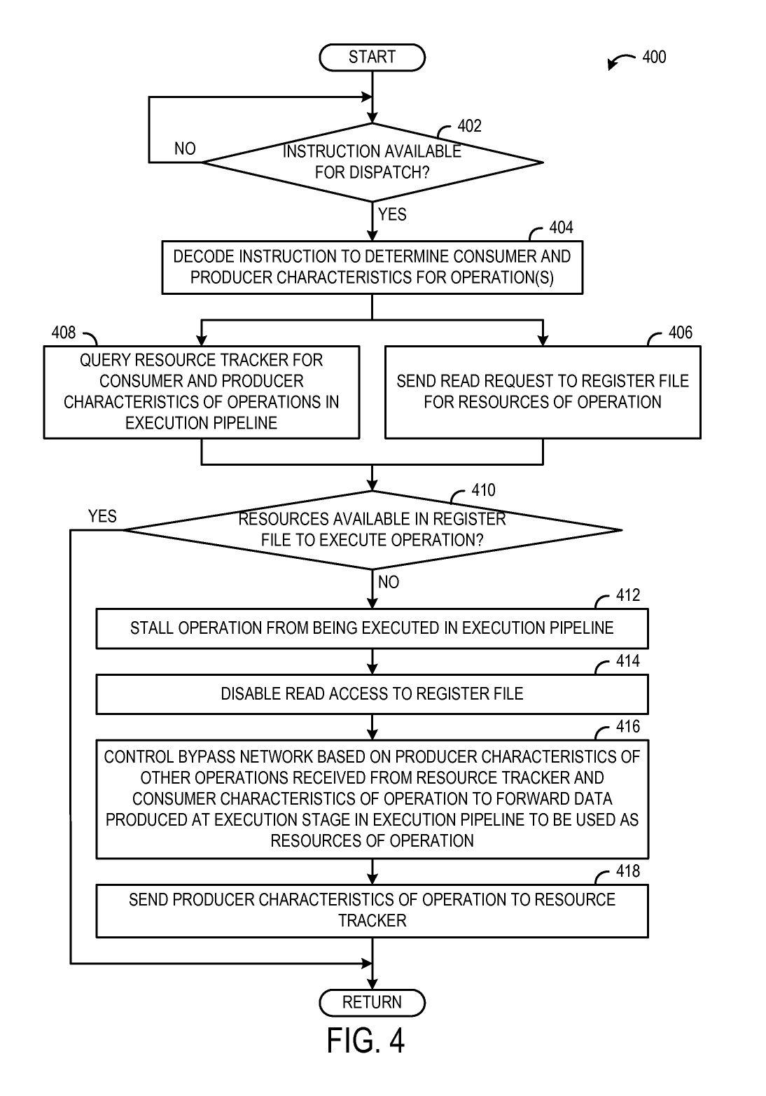

FIG. 4 shows an example method 400 for controlling an execution pipeline to reduce power consumption in accordance with an embodiment of the present disclosure. In one example, the method 400 may be executed by the scheduler 212/312 (shown in FIGS. 2 and 3) to control an execution pipeline (such as execution pipeline 200 shown in FIG. 2, or execution pipeline 300 shown in FIG. 3).

At 402, the method 400 includes determining whether an instruction is available for dispatch to the execution pipeline. If an instruction is available for dispatch to the execution pipeline, then the method 400 moves to 404/406. Otherwise, the method 400 returns to 402.

At 404, the method 400 includes decoding the instruction to determine one or more operations as well as consumer and producer characteristics of those one or more operations.

At 406, the method 400 includes sending a read request to access a register file operatively coupled with the execution pipeline for resources of the operation associated with the decoded instruction. A non-limiting example of resources of the operation includes inputs of the operation.

At 408, the method 400 includes querying a resource tracker operatively coupled with the execution pipeline for consumer and producer characteristics of other operations already being executed in the execution pipeline. In one example, the consumer characteristics include a type of operation, an execution stage in which inputs of the operation are consumed, and registers associated with the inputs of the operation. In one example, the producer characteristics include a type of operation, an execution stage in which a result of the operation is produced, and a register associated with the result of the operation.

In some embodiments, the register file and the resource tracker are accessed in parallel. In one example, the resource tracker and the register file are accessed in the first execution stage of execution pipeline.

At 410, the method 400 includes determining if the resources to execute the operation are available in the register file. In one example, it can be determined if the registers are available based on the consumer and producer characteristics of operations already in the execution pipeline. In other words, if the registers for the operation are busy waiting for data to be produced by the other operations then the resources may be unavailable. If the resources for the operation are unavailable in the register file, then the method 400 moves to 412. Otherwise, the method 400 returns to other operations.

At 412, the method 400 includes stalling the operation from being executed in the execution pipeline based on the one or more resources being unavailable in the register file.

At 414, the method 400 includes disabling read access to the register file. In one example, read access to the register file is disabled until the operation is executed in the execution pipeline, or until the operation is no longer stalled.

At 416, the method 400 includes controlling a bypass network operatively coupled to the execution pipeline based on the producer characteristics of the other operations being executed in the execution pipeline and the consumer characteristics of the stalled operation to forward data produced at an execution stage in the execution pipeline to be used as one or more resources of the operation. Read access to the register file is disabled in favor of controlling the bypass network to provide data for the operation.

At 418, the method 400 includes sending producer characteristics of the operation to the resource tracker to update the status of the resource tracker. The status of the resource tracker may be updated and used for controlling future execution of operations in the execution pipeline.

By disabling access to read the register file during a stall, continuous reads of the register file each clock cycle to check for data to become available in the register file may be avoided. In this way, power consumption of the execution pipeline may be reduced. Moreover, in some cases, the bypass network may be controlled based on the consumer and producer characteristics of operations in the execution pipeline to forward data for consumption before it may become available in the register file. In this way, performance of the execution pipeline may be increased.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A micro-processing system comprising:
an execution pipeline including a sequence of execution stages operatively coupled to a register file;
a bypass network, operatively coupled with the execution pipeline, configured to forward data produced at one or more execution stages to another execution stage earlier in the sequence of execution stages to be consumed as an input;
a resource tracker configured to track consumer and producer characteristics of operations in the execution pipeline; and
a scheduler configured to (1) stall an operation from being executed in the execution pipeline based on one or more resources of the operation being unavailable in the register file and (2) disable read access to the register file in favor of controlling the bypass network based on the consumer characteristics of the operation and the producer characteristics of other operations being executed in the execution pipeline to forward data produced at an execution stage in the execution pipeline to be used as the one or more resources of the operation.

2. The micro-processing system of claim 1, where the scheduler is configured to disable read access to the register file until the operation is no longer stalled.

3. The micro-processing system of claim 1, where the consumer characteristics include a type of operation, an execution stage in which the one or more inputs of the operation are consumed, and registers associated with the one or more inputs of the operation.

4. The micro-processing system of claim 1, where the producer characteristics include a type of operation, an execution stage in which a result of the operation is produced, and a register associated with the result of the operation.

5. The micro-processing system of claim 1, where the resource tracker is located in the execution pipeline.

6. The micro-processing system of claim 1, where the resource tracker is located in the scheduler.

7. The micro-processing system of claim 1, where the resource tracker includes a counter corresponding to each register in the register file to track when data associated with that register is consumed or produced in the execution pipeline.

8. The micro-processing system of claim 1, where the bypass network includes an early bypass configured to forward data to an execution stage of the execution pipeline and a late bypass configured to forward data to another execution stage that is located after the execution stage in the execution pipeline.

9. The micro-processing system of claim 1, where the execution pipeline is an in-order execution pipeline.

10. A method for controlling execution of an operation in an execution pipeline, comprising:
receiving consumer and producer characteristics for the operation;
sending a read request to a register file for one or more resources of the operation;
querying a resource tracker for consumer and producer characteristics of other operations being executed in the execution pipeline;
stalling the operation from being executed in the execution pipeline based on the one or more resources being unavailable in the register file; and
disabling access to read the register file in favor of controlling a bypass network based on the consumer characteristics of the operation and the producer characteristics of other operations in the execution pipeline to forward data produced at an execution stage in the execution pipeline to be used as the one or more resources of the operation.

11. The method of claim 10, where the register file and the resource tracker are accessed in parallel.

12. The method of claim 10, where access to read the register file is disabled until the operation is no longer stalled.

13. The method of claim 10, where the consumer characteristics include a type of operation, an execution stage in which inputs of the operation are consumed, and registers associated with the inputs of the operation.

14. The method of claim 10, where the producer characteristics include a type of operation, an execution stage in which a result of the operation is produced, and a register associated with the result of the operation.

15. The method of claim 10, where the resource tracker includes a counter corresponding to each register in the register file to track when data associated with that register is consumed or produced in the execution pipeline.

16. The method of claim 10, where the bypass network includes an early bypass configured to forward data to an execution stage of the execution pipeline and a late bypass configured to forward data to another execution stage that is located after the execution stage in the execution pipeline.

17. A micro-processing system comprising:
an execution pipeline including a sequence of execution stages operatively coupled to a register file;
a bypass network, operatively coupled with the execution pipeline, configured to forward data produced at one or more execution stages to another execution stage earlier in the sequence of execution stages to be consumed as an input;
a resource tracker configured to track consumer and producer characteristics of operations in the execution pipeline, where the consumer characteristics include a type of operation, an execution stage in which the one or more inputs of the operation are consumed, and registers associated with the one or more inputs of the operation, and where the producer characteristics include a type of operation, an execution stage in which a result of the operation is produced, and a register associated with the result of the operation; and
a scheduler configured to (1) stall an operation from being executed in the execution pipeline based on one or more inputs of the operation being unavailable in the register file and (2) disable access to read the register file in favor of controlling the bypass network based on the consumer characteristics of the operation and producer characteristics of other operations being executed in the execution pipeline to forward data produced at an execution stage in the execution pipeline to be used as the one or more resources of the operation.

18. The micro-processing system of claim 17, where the scheduler is configured to disable access to read the register file until the operation is no longer stalled.

19. The micro-processing system of claim 17, where the resource tracker includes a counter corresponding to each register in the register file to track when data associated with that register is consumed or produced in the execution pipeline.

20. The micro-processing system of claim 17, where the bypass network includes an early bypass configured to forward data to an execution stage of the execution pipeline and a late bypass configured to forward data to another execution stage that is located after the execution stage in the execution pipeline.
